(19) United States
(12) Patent Application Publication
(10) Pub. No.: US 2009/0313329 A1
(43) Pub. Date: Dec. 17, 2009

(54) Methods, Systems and Computer Program Products for Communication of Information in Electronic Conferences

(75) Inventors: Dakshi Agrawal, Monsey, NY (US); Dinesh C. Verma, Mount Kisco, NY (US)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 12/138,627

(22) Filed: Jun. 13, 2008

(51) Int. Cl. G06F 15/16

(52) U.S. Cl. 709/204

(57) ABSTRACT

Methods, systems and computer program products for document sharing in collaborative electronic meetings. Exemplary embodiments include a method for control of documents in a collaborative interaction, the method including establishing an out-of-band channel between a first participant and a second participant in the collaborative interaction, transferring a copy of a document on the out-of-band channel between the first participant and the second participant, transferring a command issued on the document by the first participant on an in-band channel established between the first participant and the second participant, invoking the command by the second participant on the copy of the document by the second participant and displaying the result of invoking the command to the second participant.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to user collaboration, and particularly to methods, systems and computer program products for document sharing in collaborative electronic meetings.

2. Description of Background

Collaborative interactions among users of a network are a common way for many workers to share information with each other. Colleagues with a common interest participate in a variety of collaborative interactions over a network, including but not limited to interacting and collaborating in web-conferences, web-meetings, video-conferencing, instant messaging and other types of collaborative interactions. In these conferences, documents, presentations and other types of electronic information are shared with the other participants.

In the current state of the art, the mechanism used for sharing such information tends to be relatively inefficient. In a video-conference, the contents of the screen of one participant are captured as a bit-map and the entire bit-map transferred to the remote participants. In general, the bitmaps tend to have a large amount of data, and there is a significant visible latency when this information is captured and sent remotely. When the communication latency among the different participants is large, the delay is visible. Data compression can be used to reduce the amount of information transferred, but even with compression/decompression of data, the delay can still be very large and visible. The reasons include data that cannot be compressed effectively, time taken for compression/decompression, and volume of compressed data. Thus, current means for electronic communication result in a significant delay in the delivery of the information from one participant to the rest.

As such, Web Conference meetings encounter several problems in usability and effectiveness because network latencies, jitter and processing delays at server systems cause a significant lag in the time by which presentations made at one end of the web conference can be presented to the attendees at the other end of the line. Even in an era of plentiful network bandwidth, graphics-heavy presentations and fine granularity display make the real-time nature of web-meetings very difficult.

Accordingly, there is a need to reduce the delay in transferring the contents of the screen of one participant to other participants in the conference call.

### SUMMARY OF THE INVENTION

Exemplary embodiments include a method for control of documents in a collaborative interaction, the method including establishing an out-of-band channel between a first participant and a second participant in the collaborative interaction, transferring a copy of a document on the out-of-band channel between the first participant and the second participant, transferring a command issued on the document by the first participant on an in-band channel established between the first participant and the second participant, invoking the command by the second participant on the copy of the document by the second participant and displaying the result of invoking the command to the second participant, wherein the collaborative interaction is the presentation of a document by the first participant to the second participant, wherein the out-of-band channel is established before the start of the collaborative interaction, wherein the collaborative interaction is the editing of a document jointly by the first participant and the second participant.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides the efficient management of communications among participants engaged in a collaborative interaction over a computer network. The contents of a file or other information source shared by the participants are copied on an out-of-band communication channel which is established prior to the start of the collaborative interaction. During the collaborative interaction, only commands invoked on the file are transferred among the different participants, and the commands invoked remotely over copies of the document received by the various participants. This mechanism reduces bandwidth consumed on the network, and results in a lower latency before the results of a command are seen by remote participants.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram of a document sharing system in accordance with exemplary embodiments;

FIG. 2 illustrates a document sharing method in accordance with exemplary embodiments;

FIG. 3 illustrates details of the entrance block of the document sharing method of FIG. 2;

FIG. 4 illustrates details of the interaction block of FIG. 2;

FIG. 5 illustrates a method subset of the method of FIG. 3; and

FIG. 6 illustrates a block diagram of a document sharing system in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include methods, systems and computer program products that provide the ability to transfer the contents of one participant's screen to another participant in an electronic collaborative interaction. This transferring is accomplished by employing two-channels of communication among the participants. In one channel, (the out-of-band channel) which is not part of the collaborative interaction, the contents of the document or information to be shared are copied to the remote participant's machine. The other channel (in-band channel), which is part of the collaborative interaction, control commands which manipulate and operate upon the document transferred previously over the out-of-band channel. The out-of-band channel may be established prior to active collaborative interaction begins and such documents transferred on the out-of-band channel prior to the beginning of the interaction, or the out-of-band channel may be established during the collaborative interaction, but documents transferred on the out-of-band channel prior to active commands and interactions begin on the in-band channel.

In exemplary embodiments, a web-conferencing system can be augmented so that the files used by a presenter can be transmitted on the out-of-band-channel to all participants in the web-conference. When the presenter begins his speech, his commands such as put a file into a full-screen mode, move to the next slide, start-animation, move to a previous slide, etc. are transmitted on the in-bound channel, and the commands are then performed on the copy of the file maintained at each presenter's end, which saves significantly in the bandwidth and latency of the operation in the web-conferencing system.

In further exemplary embodiments, document processor software can be augmented so that a copy of the file can be transmitted on the out-of-band channel to remote participants in a collaborative editing session. The commands invoked by the person having the control for editing the document are transmitted on the in-band channel. The commands transmitted may include all the commands that are usually available on the top menu of the document processing software.

Exemplary embodiments thus provide methods, systems and computer program products for efficient communication of information in a collaborative interaction, including establishing an out-of-band channel between a first participant and a second participant in a collaborative interaction; making a copy of a document on the out-of-band channel between the first participant and the second participant, transferring a command issued on the document by the first participant on an in-band channel established between the first participant and the second participant; invoking the command by the second participant on the copy of the document by the second participant and displaying the result of invoking the command to the second participant. The collaborative interaction may be, among other things, a web-based electronic meeting.

As described above, web-meeting network bandwidth and processing requirements can be reduced significantly, and the resulting web-meeting experience improved significantly.

In exemplary embodiments, the method can include core steps including: defining different modalities for running a web-meeting; delivering the basic files required in each presented modality to the other end in an off-line manner prior to the web-meeting; capturing and relaying the command and control functions at presenter end to the other ends; and invoking the commands and controls at the other end of the web-meeting system. The methods, systems and computer program products described herein require minimum bandwidth requirement on the network, and can significantly ease the effectiveness of meetings.

In web-conferences currently, the system runs in a mode where the contents of the screen, a selected application or a selected area of the screen on a presented are copied and relayed to the remote participants. The screen is captured by means of its bit-image, and even after compression, the contents are generally quite large so that there is a noticeable delay when a presentation moves from screen to another, both in the transmission over the network and the display on the remote end. Frequently, problems are also encountered in that the remote system only displays parts of the screen or the bit-image capture and display is distorted on the other end. In exemplary embodiments, the methods, systems and computer program products described herein implement web-conferencing, which can result in a significantly better user experience. In exemplary embodiments, the web-conferencing system is divided into different modes of operation. Example modes of operation are as follows: 1) A Dynamic Mode: When presenter screen changes in an unpredictable manner; 2) An Application Mode: When presenter is displaying/sharing a specified application and no modifications are expected from other side; and 3) An Interaction Mode: When the remote side may be collaboratively editing the application being shared. In exemplary embodiments, the application is the only one being shared.

In each of the above-described modes, the collaboration center behaves in a different manner. In the dynamic mode, the traditional method of capturing and sending the screen bitmap to the other side is followed. In the application mode, the file that the application is using is copied from the presenter's node to all of the other nodes. The copying of files may be done before the start of the web-conferencing application, and a linkage between the file being presented and the files on remote machines established as the mode is transferred and initiated. Then the web-conferencing software simply copies the keyboard and commands from the presenter's machine to the other participant's machines. The commands such as clicking on the next slide are copied to the other machines in the system. The command transfer alone takes very little bandwidth and processing on the remote machine. In the interaction mode, the commands are also copied except that control is allowed to shift from the presenter to the other machines.

In alternative embodiments of the presentation, the functionality can be bundled into the application software itself so that a presentation application (e.g., PowerPoint®) can take commands typed into it and copy them remotely to other instances of the presentation application running on other machines in the network, thereby synchronizing different copies of an application to run in the same mode.

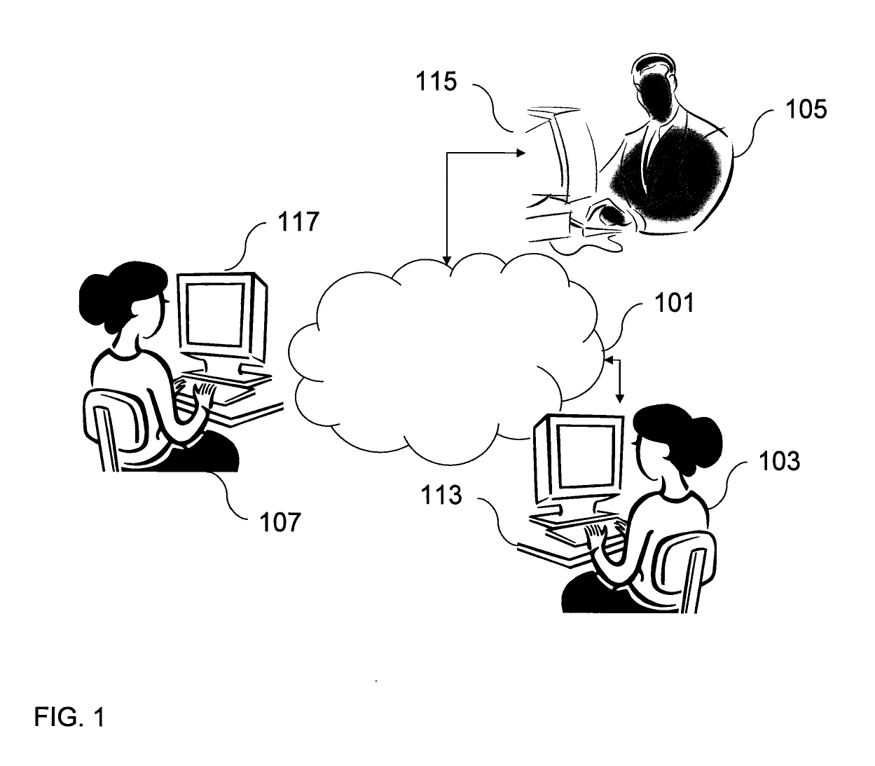

FIG. 1 illustrates a block diagram of a document sharing system 100 in accordance with exemplary embodiments. FIG. 1 illustrates three users 103, 105, 107 that are engaged in a collaborative interaction using a computer network 101. Each of the users 103, 105, 107 participates using a computing device that is connected to the network 101. The computing device may be a personal computer, a laptop, a personal digital assistant, a cell-phone or any other variety of computing devices. The computer user 103 uses the device 113, the computer user 105 uses the device 115, and the computer user 107 uses the device 117. In the collaborative interaction, the users 103, 105, 107 exchange information on their device screens with each other. Information exchanged in this way may include documents, pictures, videos, images or other form of electronic information.

In exemplary embodiments, there are many types of collaborative interactions that uses may have. One common collaborative interaction is web-presentations. In a web-presentation, a computer user, e.g. computer user 103 will be presenting a set of charts on his computer device 113, which will also be presented to computer users 105 on computer device 115 and to computer user 107 on computer device 117. In the current state of the art, conferencing software running on computers 113, 115 and 117 enable this interaction to happen. The software captures the contents of the screen of computer 113, and copies the content over to the screen of the computer 115 and 117 to enable the collaboration to happen. Other collaborative interactions include shared editing of documents, collaborative surfing of web-pages by users, participating in virtual reality environments, and playing interactive games.

With the current state of the art, the capture of the contents of the screen and transmitting it on the network takes a significant amount of data transfer. The contents of the screen of any computer user, when captured take a significant amount of time. An alternative model for communication among the users can save a significant amount of bandwidth and is described in this invention.

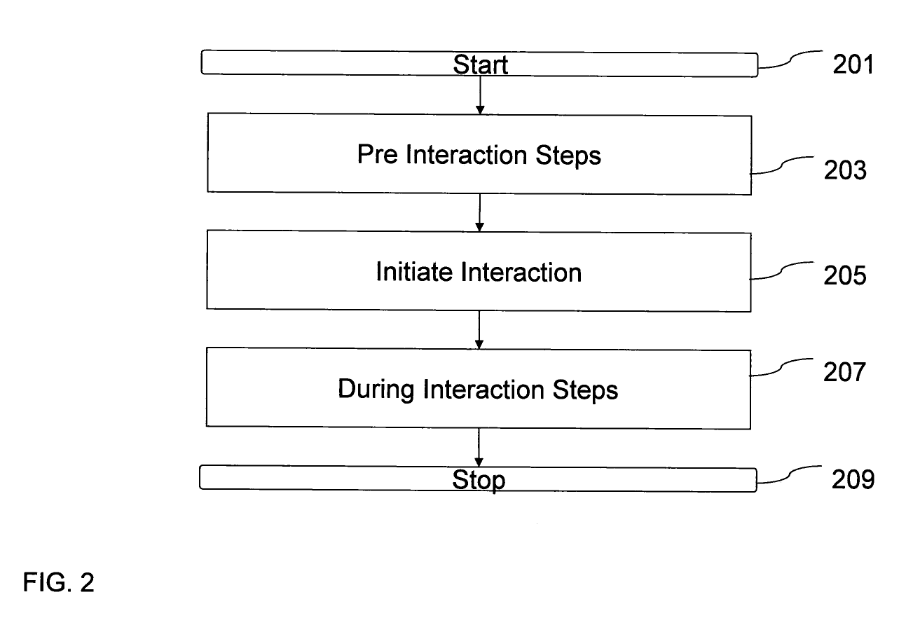

FIG. 2 illustrates a document sharing method in accordance with exemplary embodiments. The method shown in FIG. 2 is entered at block 201 by a software module at each of the participant's computers at time prior to the commencement of the actual interaction. The commencement may be at some fixed time, or at some specific event invoked by some of the participants. Subsequently, the software executes a set of pre-interaction steps at block 203. The pre-interaction steps prepare the computer parties at all collaborative interaction for an efficient communication when the interaction commences. At block 205, the software for collaborative interaction is launched. Subsequently at block 207, an efficient method resulting in reduced bandwidth and shorter latency in communication is taken by the different participants. After the interaction stops, the method terminates at block 209.

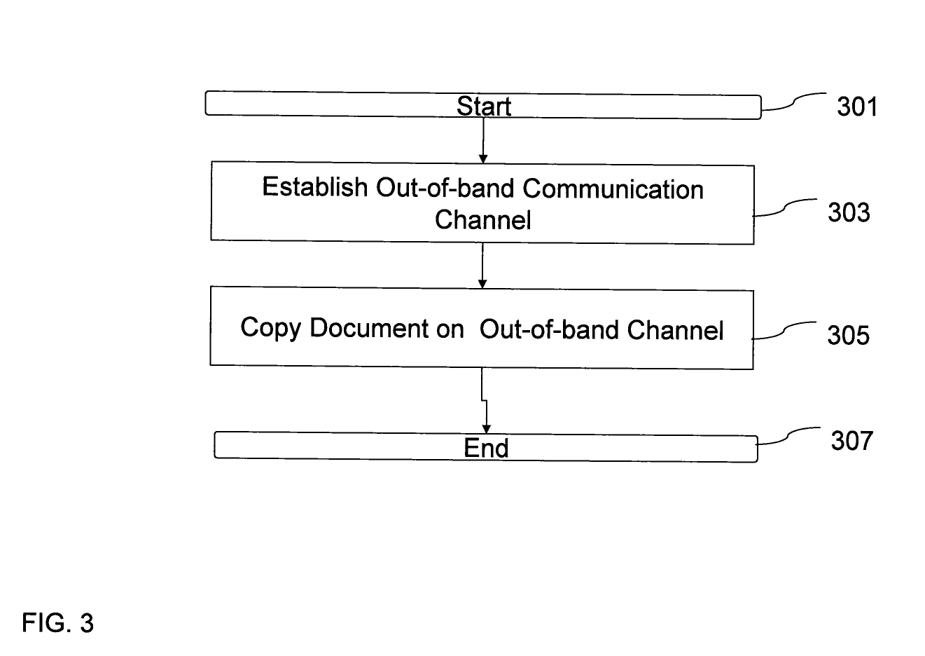

FIG. 3 illustrates details of the entrance block 201 of the document sharing method of FIG. 2. After entering the method at block 301, the software at each of the modules established an out-of-band connection among all of the participating entities in the web-based collaboration. An out-of-band connection can be established using a variety of methods, one common method being the use of a file transfer protocol to copy files from one location to another. Another method would be the use of a web-based protocol, e.g. hypertext transfer protocol to establish the out-of-band channel to remote participants. Other protocols for establishing the out-of-band protocol can also be used. Subsequently, at block 305, the out-of-band channel is used to copy the file from one participant to all of the other participants. The process then terminates at block 307.

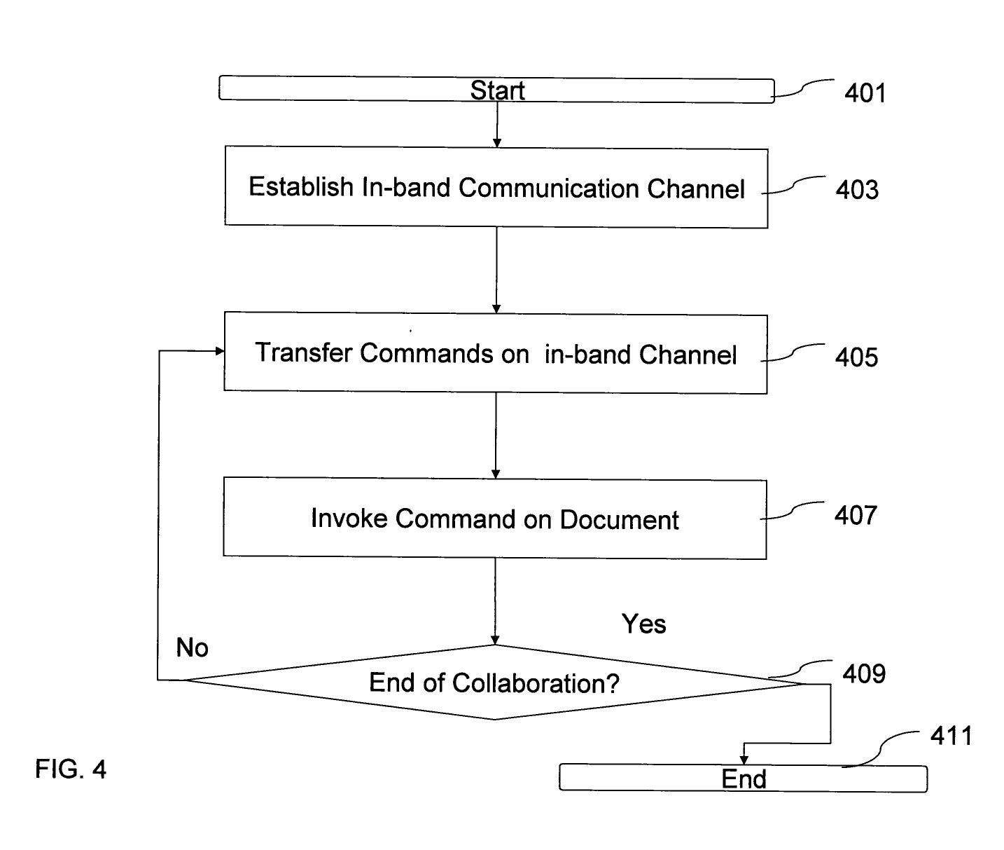

FIG. 4 illustrates details of the interaction block 207 of FIG. 2. The process is entered at block 401. Subsequently, an in-band communication channel is established for communicating among the different parties involved in a collaborative interaction at block 403. When one of the members of the parties invokes a command on the document being shared in the collaboration and transferred at block 405, the invoked command is transferred from the participant invoking the command to all of the other parties involved in the collaborative interaction in step 405. At block 407, the transferred or invoked command is applied to the document transferred at block 405 by all the participants. At block 409, the system checks if the collaboration has ended. If so, the method stops at block 411. Otherwise, the method repeats the transfer of commands at block 405.

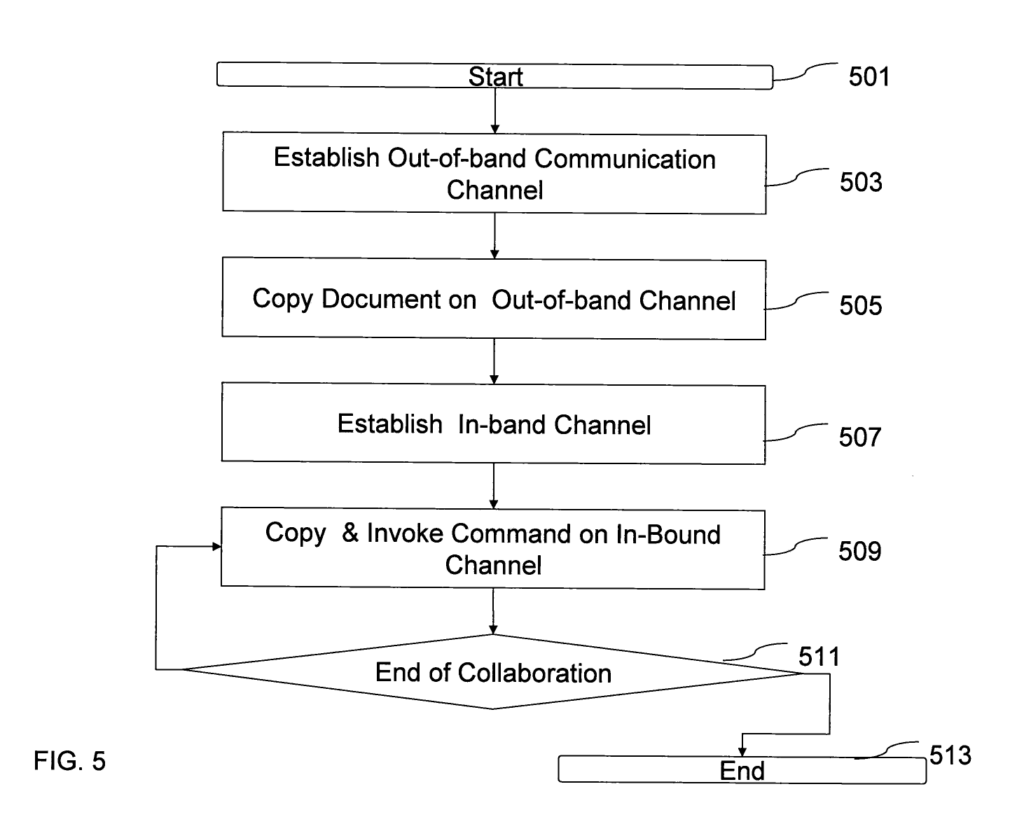

In some type of collaborative interactions, the various steps for efficient communication can be combined together after the start of the collaborative interaction. As an example, one collaborative interaction could be the shared editing of a document by various participants. The participants could start the collaborative interaction by launching word-processing software on each of their machines. The word-processing software could then interact with each other to efficiently transfer commands and other information. FIG. 5 illustrates a method subset of the method of FIG. 3. The process is entered by one of the participants involved in the collaborative interaction at block 501 at the start of the collaborative interaction. At block 503, the participants in the collaborative interaction establish an out-of-band communication channel among themselves. Such an out-of-band communication channel can be established using many protocols, including but not limited to the file transfer protocol and the hyper-text transfer protocol. At block 505, one of the participant copies a document on the out-of-band communication channel to all of the other participants. The copying can be done by one of the participants opening a document on his/her system for editing or sharing. The document is copied to all of the other participants. The document to be copied can contain information in a text format, graphics, a presentation, an image, a video, or any other form of electronic information. At block 507, the participants establish another channel, an in-and channel for communication among each other.

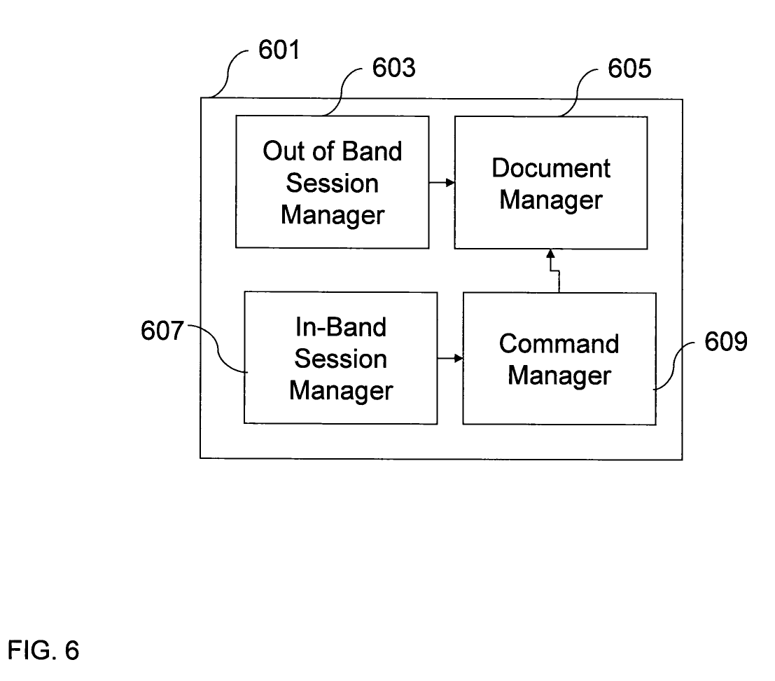

FIG. 6 illustrates a block diagram of a document sharing system in accordance with exemplary embodiments. The system may be a software module 601 implementing exemplary embodiments. The software module 601 includes an out of band session manager 603, an in band session manager 607, a document manager 605 and a command manager 609. The out-of-band session manager 603 is responsible for establishing an out-of-band communication channel, and it performs the task of sending requests for establishing such channels to other participants in the collaborative interaction, and for responding to requests for establishment of such channels from other parties involved in the interaction. The in-band session manager 607 does the same for in-band communication channel. The document manager 605 uses the out-of-band communication channel to copy documents between different participants. The document manager maintains a copy of the document being shared as the local copy. The command manager 609 receives commands from the local user, or on the in-band channel from other participants in the collaborative interaction, and it invokes the commands on the local copy of the document maintained by the document manager.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for control of documents in a collaborative interaction, the method consisting of:
establishing an out-of-band channel between a first participant and a second participant in the collaborative interaction;
transferring a copy of a document on the out-of-band channel between the first participant and the second participant;
transferring a command issued on the document by the first participant on an in-band channel established between the first participant and the second participant;
invoking the command by the second participant on the copy of the document by the second participant; and
displaying the result of invoking the command to the second participant,

2. The method as claimed in claim 1 wherein the collaborative interaction is the presentation of a document by the first participant to the second participant,

3. The method as claimed in claim 1 wherein the out-of-band channel is established before the start of the collaborative interaction,

4. The method as claimed in claim 1 wherein the collaborative interaction is the editing of a document jointly by the first participant and the second participant.
